(19) United States
(12) Patent Application Publication
(10) Pub. No.: US 2024/0036412 A1
(43) Pub. Date: Feb. 1, 2024

(54) DISPLAY PANEL AND ELECTRONIC DEVICE

(71) Applicant: TCL China Star Optoelectronics Technology Co., Ltd., Shenzhen, Guangdong (CN)

(72) Inventor: Xi CHENG, Shenzhen, Guangdong (CN)

(21) Appl. No.: 17/593,321

(22) PCT Filed: Jun. 9, 2021
(86) PCT No.: PCT/CN2021/099063

§ 371 Date: Sep. 15, 2021

(30) Foreign Application Priority Data
May 31, 2021 (CN) 202110598135.2

(51) Int. Cl. G02F 1/1362; G02F 1/1343

(52) U.S. Cl. CPC G02F 1/136286; G02F 1/134309

(57) ABSTRACT

A display panel and an electronic device are provided. The display panel includes a plurality of scan lines, a plurality of data lines, and a plurality of sub-pixel units. Wherein, every N adjacent rows of the sub-pixel units share a same scan line. Every N adjacent strips of the data lines correspond to the sub-pixel units in a same column. In the sub-pixel units in a same column, every N adjacent rows of the sub-pixel units form a pixel group. The sub-pixel units in each pixel group are connected to N strips of the data lines in a one-to-one correspondence. N is a positive integer greater than or equal to four.

### FIELD

The present disclosure relates to a field of display technologies, and more particularly, to a display panel and an electronic device.

### BACKGROUND

With development of display technologies, an issue of low charging efficiency of large-scale and high-resolution liquid crystal display (LCD) panels has aroused wide concern. Nowadays, to improve charging efficiency of large-scale display panels, a half-gate two-data (HG2D) structure is applied to the display panels. Specifically, one column of sub-pixel units corresponds to two data lines. This structure has doubled charging time compared with conventional structures, improving charging efficiency of display panels.

However, with continuous improvement of display resolution (especially in great demand of high refresh-rate display products), charging time of sub-pixel units is very short, causing issues of undercharging and uneven images to be displayed.

### SUMMARY

The present disclosure provides a display panel and an electronic device to solve following technical issues: in conventional technologies, charging time of high refresh-rate display products is short, causing undercharging of sub-pixel units.

The present disclosure provides a display panel, comprising:
a plurality of scan lines arranged in a column direction;
a plurality of data lines arranged in a row direction; and
a plurality of sub-pixel units arranged in an array manner;
wherein every N adjacent rows of the sub-pixel units are connected to a same scan line, and every N adjacent strips of the data lines correspond to the sub-pixel units in a same row; and in the sub-pixel units in a same row, every N adjacent rows of the sub-pixel units form a pixel group, the sub-pixel units of each pixel group are connected to N strips of the data lines in a one-to-one correspondence, and N is a positive integer greater than or equal to four.

Optionally, in some embodiments of the present disclosure, when N is equal to four, each of the scan lines comprises four sub-scan lines, and one of the sub-scan lines is disposed between two adjacent rows of the sub-pixel units.

Optionally, in some embodiments of the present disclosure, the four sub-scan lines corresponding to a same scan line are parallelly connected to each other.

Optionally, in some embodiments of the present disclosure, when N is equal to four, in every four adjacent rows of the sub-pixel units, the scan lines are disposed between any two adjacent rows of the sub-pixel units.

Optionally, in some embodiments of the present disclosure, when N is equal to four, in four adjacent data lines corresponding to the sub-pixel units in a same column, one of the data lines is disposed on a left side of the sub-pixel units in the same column, one of the data lines is disposed on a right side of the sub-pixel units in the same column, and two of the data lines in a middle side are disposed in an area corresponding to the sub-pixel units in the same column.

Optionally, in some embodiments of the present disclosure, the sub-pixel units comprise a pixel electrode, the pixel electrode comprises a first stem part and a second stem part perpendicular to each other, the first stem part extends along the column direction, and the first stem part overlaps with at least one of the two of the data lines in the middle side.

Optionally, in some embodiments of the present disclosure, when N is equal to four, in four adjacent data lines corresponding to the sub-pixel units in a same column, two of the data lines are disposed on a left side of the sub-pixel units in the same column, and another two of the data lines are disposed on a right side of the sub-pixel units in the same column; and
one of the two of the data lines disposed on a side of the sub-pixel units in the same column is connected to a corresponding sub-pixel unit.

Optionally, in some embodiments of the present disclosure, voltage polarities of two adjacent data lines is opposite.

Optionally, in some embodiments of the present disclosure, the sub-pixel units comprise a first lateral edge and a second lateral edge adjacent to each other, a length of the first lateral edge is greater than a length of the second lateral edge, and an extending direction of the data lines is parallel to the second lateral edge.

Optionally, in some embodiments of the present disclosure, the sub-pixel units comprise a plurality of red sub-pixel units, a plurality of green sub-pixel units, and a plurality of blue sub-pixel units, in the sub-pixel units in a same column, the red sub-pixel units, the green-pixel units, and the blue sub-pixel units are repeatedly arranged in any sequence, and the sub-pixel units in a same row have a same color.

Optionally, in some embodiments of the present disclosure, the sub-pixel units comprise a plurality of red sub-pixel units, a plurality of green sub-pixel units, a plurality of blue sub-pixel units, and a plurality of white sub-pixel units, in the sub-pixel units in a same column, the red sub-pixel units, the green-pixel units, the blue sub-pixel units, and the white sub-pixel units are repeatedly arranged in any sequence, and the sub-pixel units in a same row have a same color.

Correspondingly, the present disclosure further provides an electronic device, comprising a display panel, wherein the display panel comprises:
a plurality of scan lines arranged in a column direction;
a plurality of data lines arranged in a row direction; and
a plurality of sub-pixel units arranged in an array manner;
wherein every N adjacent rows of the sub-pixel units are connected to a same scan line, and every N adjacent strips of the data lines correspond to the sub-pixel units in a same row; and in the sub-pixel units in a same row, every N adjacent rows of the sub-pixel units form a pixel group, the sub-pixel units of each pixel group are connected to N strips of the data lines in a one-to-one correspondence, and N is a positive integer greater than or equal to four.

Optionally, in some embodiments of the present disclosure, when N is equal to four, each of the scan lines comprises four sub-scan lines, and one of the sub-scan lines is disposed between two adjacent rows of the sub-pixel units.

Optionally, in some embodiments of the present disclosure, the four sub-scan lines corresponding to a same scan line are parallelly connected to each other.

Optionally, in some embodiments of the present disclosure, when N is equal to four, in every four adjacent rows of the sub-pixel units, the scan lines are disposed between any two adjacent rows of the sub-pixel units.

Optionally, in some embodiments of the present disclosure, when N is equal to four, in four adjacent data lines corresponding to the sub-pixel units in a same column, one of the data lines is disposed on a left side of the sub-pixel units in the same column, one of the data lines is disposed on a right side of the sub-pixel units in the same column, and two of the data lines in a middle side are disposed in an area corresponding to the sub-pixel units in the same column.

Optionally, in some embodiments of the present disclosure, the sub-pixel units comprise a pixel electrode, the pixel electrode comprises a first stem part and a second stem part perpendicular to each other, the first stem part extends along the column direction, and the first stem part overlaps with at least one of the two of the data lines in the middle side.

Optionally, in some embodiments of the present disclosure, when N is equal to four, in four adjacent data lines corresponding to the sub-pixel units in a same column, two of the data lines are disposed on a left side of the sub-pixel units in the same column, and another two of the data lines are disposed on a right side of the sub-pixel units in the same column; and
one of the two of the data lines disposed on a side of the sub-pixel units in the same column is connected to a corresponding sub-pixel unit.

Optionally, in some embodiments of the present disclosure, the sub-pixel units comprise a first lateral edge and a second lateral edge adjacent to each other, a length of the first lateral edge is greater than a length of the second lateral edge, and an extending direction of the data lines is parallel to the second lateral edge.

Optionally, in some embodiments of the present disclosure, the sub-pixel units comprise a plurality of red sub-pixel units, a plurality of green sub-pixel units, a plurality of blue sub-pixel units, and a plurality of white sub-pixel units, in the sub-pixel units in a same column, the red sub-pixel units, the green-pixel units, the blue sub-pixel units, and the white sub-pixel units are repeatedly arranged in any sequence, and the sub-pixel units in a same row have a same color.

Regarding the beneficial effects: the present disclosure provides a display panel and an electronic device. The display panel includes a plurality of scan lines, a plurality of data lines, and a plurality of sub-pixel units. Every N adjacent rows of the sub-pixel units share a same scan line. Every N adjacent strips of the data lines correspond to the sub-pixel units in a same column. In the sub-pixel units in a same column, every N adjacent rows of the sub-pixel units form a pixel group, the sub-pixel units of each pixel group are connected to N strips of the data lines in a one-to-one correspondence. N is a positive integer greater than or equal to four. The present disclosure uses one scan line to control N rows of sub-pixel units. In addition, the sub-pixel units in each column are correspondingly connected to N strips of the data lines. Therefore, charging time of the pixel units can be effectively increased, which satisfies requirements of high fresh-rate display.

### DESCRIPTION OF DRAWINGS

The accompanying figures to be used in the description of embodiments of the present disclosure or prior art will be described in brief to more clearly illustrate the technical solutions of the embodiments or the prior art. The accompanying figures described below are only part of the embodiments of the present disclosure, from which those skilled in the art can derive further figures without making any inventive efforts.

FIG. 1 is a first structural schematic view showing a display panel provided by the present disclosure.

FIG. 2 is a second structural schematic view showing a display panel provided by the present disclosure.

FIG. 3 is a third structural schematic view showing a display panel provided by the present disclosure.

FIG. 4 is a fourth structural schematic view showing a display panel provided by the present disclosure.

FIG. 5 is a fifth structural schematic view showing a display panel provided by the present disclosure.

FIG. 6 is a sixth structural schematic view showing a display panel provided by the present disclosure.

FIG. 7 is a cross-sectional structural schematic view showing part of the display panel in FIG. 6 provided by the present disclosure.

FIG. 8 is a seventh structural schematic view showing a display panel provided by the present disclosure.

FIG. 9 is an eighth structural schematic view showing a display panel provided by the present disclosure.

FIG. 10 is a ninth structural schematic view showing a display panel provided by the present disclosure.

FIG. 11 is a structural schematic view showing an electronic device provided by the present disclosure.

### DETAILED DESCRIPTION

Hereinafter a preferred embodiment of the present disclosure will be described with reference to the accompanying drawings to exemplify the embodiments of the present disclosure can be implemented, which can fully describe the technical contents of the present disclosure to make the technical content of the present disclosure clearer and easy to understand. However, the described embodiments are only some of the embodiments of the present disclosure, but not all of the embodiments. All other embodiments obtained by those skilled in the art based on the embodiments of the present disclosure without creative efforts are within the scope of the present disclosure. In the present disclosure, unless further description is made, terms such as “top”, “bottom”, “left”, and “right” usually refer to a top side of a device, a bottom side of a device, a left side of a device, and a right side of a device in an actual process or working status, and specifically, to the orientation as shown in the drawings.

An embodiment of the present disclosure provides a display panel and an electronic device which are respectively described below in detail. It should be noted that the description order of embodiments does not mean preferred orders of the embodiments. In the above embodiments, the focus of each embodiment is different, and for a part that is not detailed in an embodiment, reference may be made to related descriptions of other embodiments.

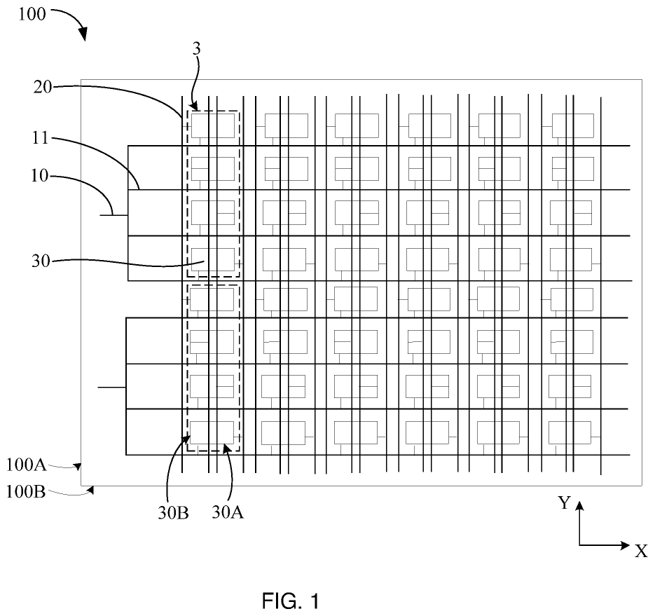

As shown in FIG. 1, a first structural view showing a display panel provided by the present disclosure is provided. In the present disclosure, a display panel 100 includes a plurality of scan lines 10, a plurality of data lines 20, and a plurality of sub-pixel units 30. The scan lines 10 are arranged along a column direction. The data lines 20 are arranged along a row direction. The sub-pixel units 30 are arranged in an array manner. Wherein, every N adjacent rows of the sub-pixel units 30 share a same scan line 10, every N adjacent strips of the data lines 20 correspond to the sub-pixel units 30 in a same row. In the sub-pixel units 30 in a same column, every N adjacent rows of the sub-pixel units 30 form a pixel group 3, the sub-pixel units 30 of each pixel group 3 are connected to N strips of the data lines 20 in a one-to-one correspondence, and N is a positive integer greater than or equal to four.

In the present disclosure, the row direction is a direction extending along an X direction, and the column direction is a direction extending along a Y direction. A first direction X and a second direction Y may be perpendicular to each other, or may be only cross each other but not perpendicular to each other. Of course, in some embodiments, the row direction may be the direction extending along the Y direction, and the column direction may be the direction extending along the X direction. Drawings are only examples and do not limit the present disclosure.

In the present disclosure, a material of the scan lines 10 and a material of the data lines 20 may be any one of Ag, Al, Ni, Cr, Mo, Cu, W, or Ti. Above metals have good conductivity and low cost. Therefore, conductivity of the scan lines 10 and the data lines 20 can be ensured while production cost of the scan lines 10 and the data lines 20 can be reduced. The material of the scan lines 10 and the material of the data lines 20 may also be any one of indium gallium zinc oxide (IGZO), indium zinc tin oxide (IZTO), indium gallium zinc tin oxide (IGZTO), indium tin oxide (ITO), indium zinc oxide (IZO), indium aluminum zinc oxide (IAZO), indium gallium tin oxide (IGTO), or antimony tin oxide (ATO). Above-mentioned transparent metal oxide materials have good conductivity, good transparency, and a relatively small thickness. As such, an entire thickness of the display panel 100 would not be affected.

In the present disclosure, a number of the scan lines 10 and a number of the data lines 20 can be determined according to a size and resolution of the display panel 100, which is not limited by the present disclosure.

In the present disclosure, the sub-pixel units 30 may be red sub-pixel units, green sub-pixel units, blue sub-pixel units, white sub-pixel units, yellow sub-pixel units, etc., which is not limited by the present disclosure. For example, the display panel 100 provided by the present disclosure may have a standard red-green-blue (RGB) pixel arrangement structure, an RGB pentile pixel arrangement structure, an RGB delta pixel arrangement structure, or a red-green-blue-white (RGBW) pixel arrangement structure, which can be determined according to an actual requirement.

In the present disclosure, N is a positive integer greater than or equal to four. For example, when N is equal to four, every four adjacent rows of the sub-pixel units 30 share a same scan line 10, and every four adjacent strips of the data lines 20 correspond to the sub-pixel units 30 in a same column. In the sub-pixel units 30 in a same column, every four adjacent rows of the sub-pixel units 30 form a pixel group 3, and the sub-pixel units 30 in each pixel group 3 are connected to four data lines 20 in a one-to-one correspondence. Furthermore, when N is equal to five, every five adjacent rows of the sub-pixel units 30 share a same scan line 10. In the sub-pixel units 30 in a same column, every five adjacent rows of the sub-pixel units 30 form the pixel group 3, and the sub-pixel units 30 in each pixel group 3 are connected to five data lines 20 in one-to-one correspondence.

The present disclosure uses one scan line 10 to control N rows of the sub-pixel units 30, and the sub-pixel units 30 in each column are correspondingly connected to N strips of the data lines 20. Therefore, when the scan line 10 outputs a scan signal, N rows of the sub-pixel units 30 can be correspondingly controlled and can be simultaneously charged. As such, a period of each of the scan lines 10 outputting a scan signal can be increased, thereby further increasing a charging time of the display panel 100. As a result, the sub-pixel units 30 can be fully charged, and requirements of a high refresh-rate display can be satisfied.

In following embodiments of the present disclosure, N is taken as four to describe technical solutions provided by the present disclosure, which cannot be understood as a limitation to the present disclosure.

Please refer to FIG. 1 again, in some embodiments of the present disclosure, the sub-pixel units 30 include a first lateral edge 30A and a second lateral edge 30B adjacent to each other. A length of the first lateral edge 30A is greater than a length of the second lateral edge 30B. An extending direction of the data lines 20 is parallel to an extending direction of the second lateral edge 30B.

That is, the display panel 100 of the present disclosure has a tri-gate structure that is a common structure able to reduce cost. In the tri-gate structure, every sub-pixel unit 30 is rotated 90 degrees. For example, when the sub-pixel units 30 have an RGB arrangement structure, a number of the scan lines 10 is increased three times, and a number of the data lines 20 is decreased three times. Since cost of data chips are relatively high, the above-mentioned method can reduce a usage amount of the data chips, thereby reducing cost.

It should be understood that the extending direction of the data lines 20 is parallel to a first lateral edge 100A. A length of the data lines 20 is relatively great, and a transmit path of a data signal is relatively long, causing failure of completing a charging process. The present disclosure uses one scan line 10 to control four rows of the sub-pixel units 30, and the sub-pixel units 30 in each row are correspondingly connected to four data lines 20. When the scan lines 10 output a scan signal, four rows of the sub-pixel units 30 can be corresponding controlled and can be simultaneously charged. Therefore, a period of each scan line 10 outputting a scan signal can be increased. As such, a transmit time of a data signal in the data lines 20 can be further increased, thereby satisfying charging requirements.

In addition, the display panel 100 includes a first lateral edge 100A and a second lateral edge 100B adjacent to each other. A length of the first lateral edge 100A is greater than a length of the second lateral edge 1008. The extending direction of the data lines 20 is parallel to an extending direction of the first lateral edge 100A. In the present disclosure, since the length of the first edge 100A is greater than the length of the second lateral edge 1008, the extending direction of the data lines 20 is set to be parallel to the first lateral edge 100A. As such, the number of the data lines 20 is further reduced, and therefore the usage amount of the data chips is reduced.

Of course, in other embodiments of the present disclosure, the display panel 100 may not have the tri-gate structure. That is, the sub-pixel units 30 are horizontally arranged. A third lateral edge 30A of the sub-pixel units 30 is parallel to a first lateral edge 100A. Likewise, in the present embodiment, N rows of the sub-pixel units 30 are controlled by one scan line 10, and the sub-pixel units 30 in each column are correspondingly connected to N strips of the data lines 20. Therefore, when the scan lines 10 output a scan signal, N rows of the sub-pixel units 30 can be controlled and charged simultaneously, thereby increasing a period of each scan line 10 outputting the scan signal. That is, this solution can increase the charging time of the display panel 100, thereby sufficiently charging the sub-pixel units 30 to satisfy the requirements of the high refresh-rate display.

Please refer to FIG. 1 again, in some embodiments of the present disclosure, each of the scan lines 10 includes four sub-scan lines 11. Each of the sub-scan lines 11 is disposed between two adjacent rows of the sub-pixel units 30. Each row of the sub-pixel units 30 is correspondingly connected to one sub-scan line 11. It should be understood that four sub-scan lines 11 receive a same scan signal.

It should be understood that the sub-scan line 11 is disposed on a first row of the sub-pixel units 30 or is disposed below a last row of the sub-pixel units 30 to ensure that each row of the sub-pixel units 30 has a corresponding sub-scan line 11.

In the present disclosure, each of the scan lines 10 includes four sub-scan lines 11. Therefore, a width of the sub-pixel lines 11 can be set to be relatively small, thereby allowing the sub-scan lines 11 to be disposed in a gap between two adjacent rows of the pixel units 30. Therefore, an aperture ratio of the display panel 100 can be prevented from being affected by the sub-scan lines 10.

Please refer to FIG. 1 again, in some embodiments of the present disclosure, in four adjacent data lines 20 corresponding to the sub-pixel units in a same column. One of the data lines 20 is disposed on a left side of the sub-pixel units 30 in a same column, one of the data lines 20 is disposed on a right side of the sub-pixel units 30 in a same column, and two of the data lines in a middle side are disposed in an area corresponding to the sub-pixel units in a same column. Wherein, the four adjacent data lines 20 disposed corresponding to the sub-pixel units 30 in the same column are sequentially cross-connected to the sub-pixel units 30.

Specifically, when voltage polarities of each of the data lines 20 are a same, four sub-pixel units 30 and four data lines 20 in each pixel group 3 can be connected to each other in a one-to-one correspondence.

Please refer to FIG. 1, the pixel group 3 in the following description will be described from top to bottom. A first sub-pixel unit 30 is connected to a first one of the data lines 20 counted from a left side. A second sub-pixel unit 30 is connected to a second one of the data lines 20 counted from the left side. A third sub-pixel unit 30 is connected to a third one of the data lines 20 counted from the left side. A fourth sub-pixel unit 30 is connected to a fourth one of the data lines 20 counted from the left side.

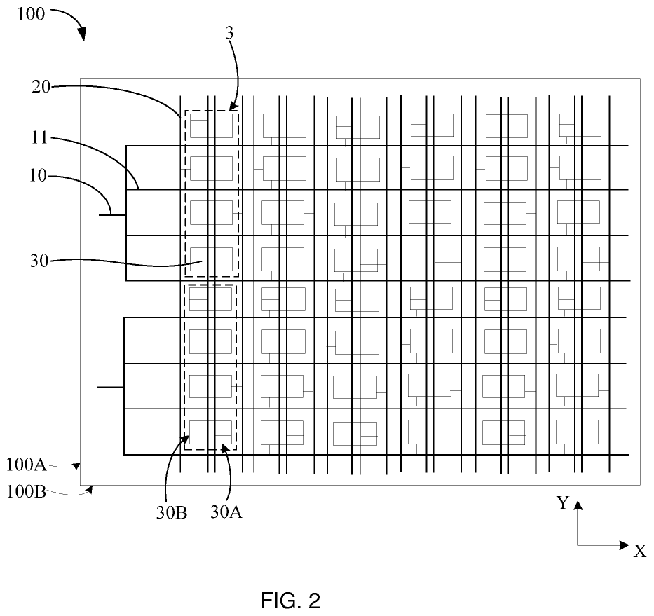

Furthermore, as shown in FIG. 2, a second structural schematic view showing a display panel provided by the present disclosure is provided. A difference between the display panel 100 as shown in FIG. 1 and the display panel as shown in FIG. 2 is the pixel group 3. The pixel group 3 of the present embodiment is also described from top to bottom in the following description. A first sub-pixel unit 30 is connected to a second one of the data lines 20 counted from a left side. A second sub-pixel unit 30 is connected to a first one of the data lines 20 counted from the left side. A third sub-pixel unit 30 is connected to a fourth one of the data lines 20 counted from the left side. A fourth sub-pixel unit 30 is connected to a third one of the data lines 20 counted from the left side.

In the present embodiment, two of the four adjacent data lines 20 in a middle side corresponding to the sub-pixel units 30 in a same column are disposed in an area corresponding to the sub-pixel units 30 in the same column. Therefore, the four data lines 20 can be disposed on a same layer. As such, a thickness of the display panel 100 can be reduced, and manufacturing processes can be simplified as well.

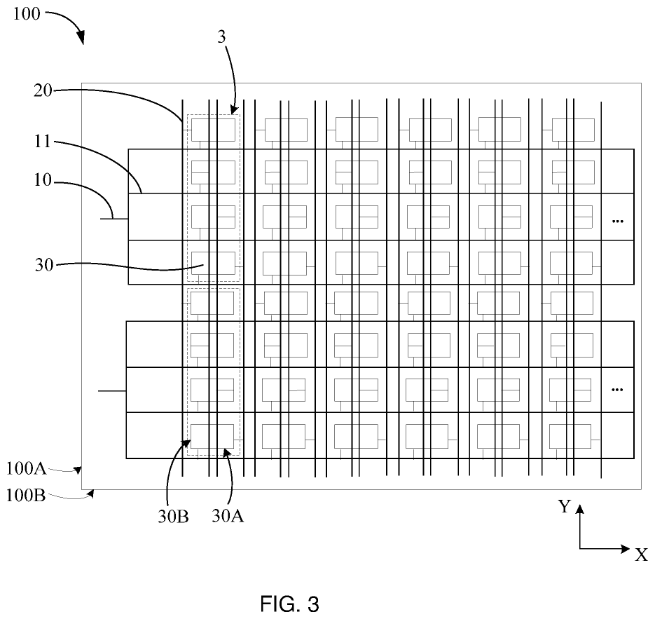

As shown in FIG. 3, a third structural schematic view showing a display panel provided by the present disclosure is provided. A difference between the display panel 100 as shown in FIG. 1 and the display panel as shown in FIG. 3 is: in the present embodiment, four sub-scan lines 11 corresponding to a same scan line 10 are parallel-connected to each other. It should be understood that each of the sub-scan lines 11 has a certain electrical resistance which causes IR drop that affects transmission of a scan signal in the scan lines 11. Consequently, display uniformity of the display panel 100 is affected. In the present embodiment, four sub-scan lines 11 corresponding to a same scan line are parallel-connected to each other. Therefore, electrical resistance of corresponding scan lines 10 can be effectively reduced, and IR drop due to the scan lines 10 can be reduced.

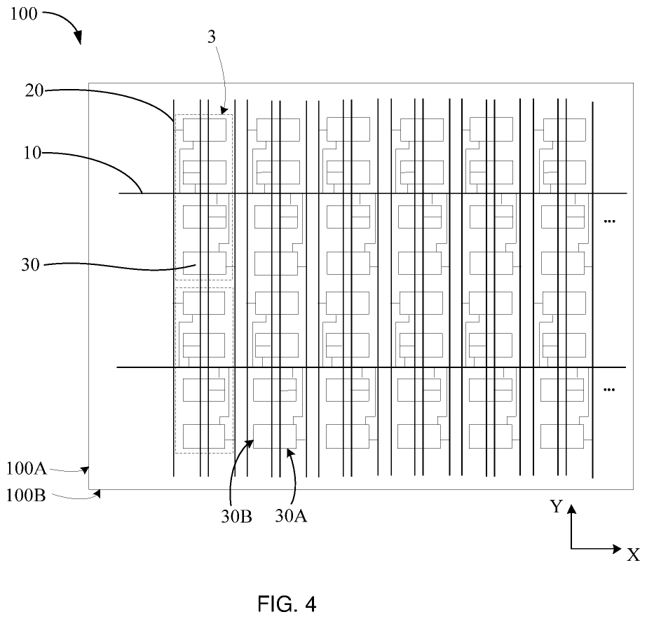

Please refer to FIG. 4, a fourth structural schematic view showing a display panel provided by the present disclosure is provided. A difference between the display panel 100 as shown in FIG. 1 and the display panel as shown in FIG. 4 is: in the present embodiment, in every four adjacent rows of the sub-pixel units 30, only one scan line 10 is provided. The scan line 10 is disposed between any two adjacent rows of the sub-pixel units 30.

For example, as shown in FIG. 4, in every four adjacent rows of the sub-pixel units 30, the scan line 10 is disposed in a gap between a second row of the sub-pixel units 30 and a third row of the sub-pixel units 30. In every four adjacent rows of the sub-pixel units 30, each of the sub-pixel units 30 is connected to a same scan line 10 by a connecting line. Wherein, the connecting line and the scan line 10 are disposed on a same layer. A connecting method of the connecting line can be determined according to a positional relationship between each of the subpixel units 30 and its corresponding scan line 10.

In the present embodiment, in every four adjacent rows of the sub-pixel units 30, the scan line 10 is disposed between the second row of the sub-pixel units 30 and the third row of the sub-pixel units 30. Therefore, the scan line 10 is disposed in a middle of the sub-pixel units 30, thereby improving distribution uniformity of the connecting lines. In addition, since only one scan line 10 is disposed in every four adjacent rows of the sub-pixel units 30, conductive metals in the display panels 100 can be reduced, and a width of the scan line 10 can be set to be relatively greater. As such, electrical resistance of the scan line 10 can be reduced, thereby reducing IR drop due to the scan line 10.

Of course, in other embodiments, in every four adjacent rows of the sub-pixel units 30, the scan line 10 may also be disposed in a gap between the first row of the sub-pixel units 30 and the second row of the sub-pixel units 30. Alternatively, the scan lines 10 may be disposed in a gap between the third row of the sub-pixel units 30 and a fourth row of the sub-pixel units 30.

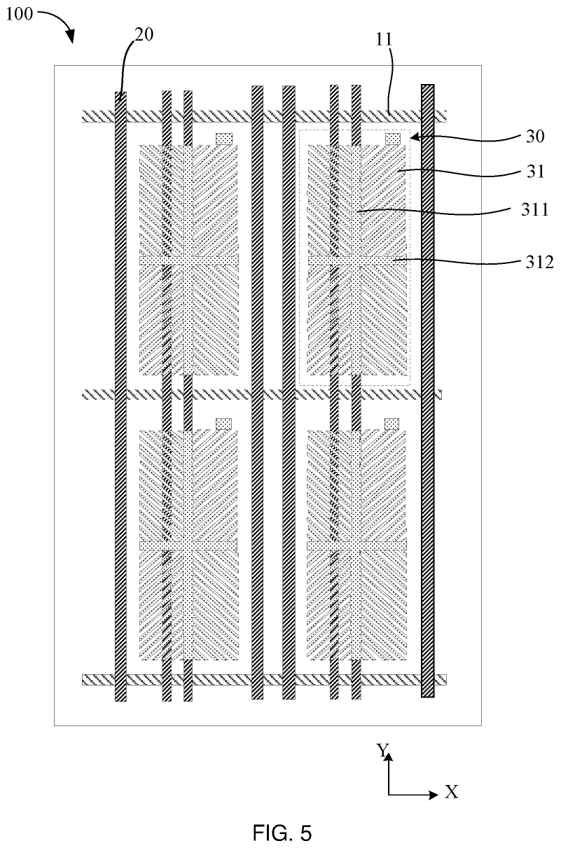

Please refer to FIG. 5, a fifth structural schematic view showing a display panel provided by the present disclosure is provided. A difference between the display panel 100 as shown in FIG. 1 and the display panel as shown in FIG. 5 is: in the present embodiment, the sub-pixel units 30 include a pixel electrode 31. The pixel electrode 31 includes a first stem part 311 and a second stem part 312 perpendicular to each other. The first stem part 311 extends along a column direction. In four adjacent data lines 20 corresponding to the sub-pixel units 30 in a same column, the first stem part 311 overlaps with at least one of the two data lines 20 in a middle.

Wherein, the first stem part 311 and the second stem part 312 may divide the pixel electrode 31 into a four-domain electrode or an eight-domain electrode. In the present disclosure, the four-domain electrode is taken as an example for description, which cannot be understood as a limitation to the present disclosure.

Wherein, the pixel electrode 31 is made of a transparent conductive material such as indium tin oxide (ITO) or indium zinc oxide (IZO). In four adjacent data lines 20 corresponding to the sub-pixel units 30 in a same column, a material of two data lines 20 in the middle is a non-transparent material having low resistivity such as Cu, Al, Ag, or Mo. Alternatively, the material of the two data lines 20 in the middle may be a transparent material having relatively low resistivity such as a carbon nanotube or graphene, thereby reducing influence of the two data lines 20 in the middle on an aperture ratio of the sub-pixel units 30.

In the present embodiment, the first stem part 311 overlaps with the two data lines 20 in the middle, thereby increasing the aperture ratio of the sub-pixel units 30. That is, an orthographic projection of the first stem part 311 on a substrate (not shown) of the display panel 100 overlaps with at least part of an orthographic projection of the two data lines 20 in the middle on the substrate. Preferably, the first stem part 311 overlaps with the two data lines 20 in the middle as much as possible.

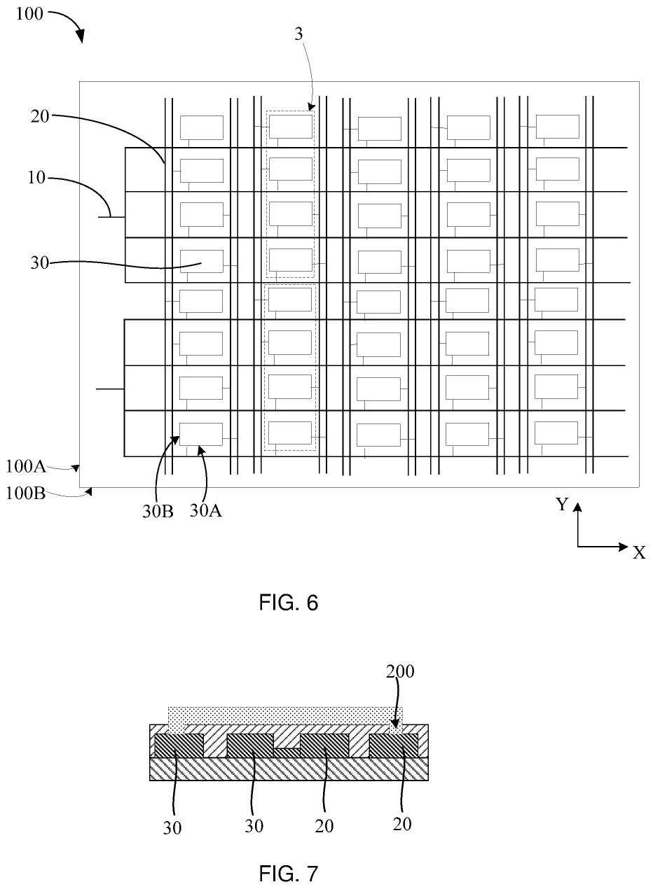

Please refer to FIG. 6, a sixth structural schematic view showing a display panel provided by the present disclosure is provided. A Difference between the display panel 100 as shown in FIG. 1 and the display panel as shown in FIG. 6 is: in the present embodiment, in four adjacent data lines 20 corresponding to the sub-pixel units 30 in a same column, two data lines 20 are disposed on a left side of the sub-pixel units 30 in the same column, and another two data lines 20 are disposed on a right side of the sub-pixel units 30 in the same column.

Specifically, please refer to FIG. 7, a cross-sectional structural schematic view showing part of the display panel in FIG. 6 is provided. One of the two data lines 20 on a side of the sub-pixel units 30 in a same column is connected to the sub-pixel units 30 by a through-hole.

It should be understood that since the four adjacent data lines 20 are correspondingly connected to the sub-pixel units 30 in a same column through lines and one side of the sub-pixel units 30 in a same column is provided with two data lines 20, the lines are prone to cross each other. To prevent transmission failure of a signal due to lines crossing each other, one of two data lines need to be connected to a corresponding sub-pixel unit 30 by a through-hole 200 when the two data lines 20 on a side of the sub-pixel units 30 in a same column are disposed on a same layer.

In the present embodiment, four adjacent data lines 20 corresponding to the sub-pixel units 30 in a same column are disposed on two sides of the sub-pixel units 30 in the same column. That is, the four adjacent data lines 20 corresponding to the sub-pixel units 30 in the same column are disposed in a gap between adjacent columns of the sub-pixel units 30. As such, an aperture ratio of the display panel 100 can be increased.

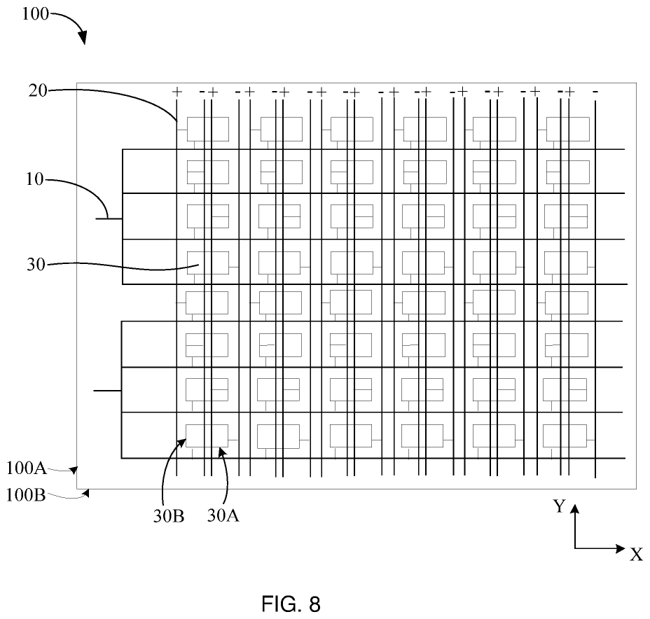

Please refer to FIG. 8, a seventh structural schematic view showing a display panel provided by the present disclosure is provided. A difference between the display panel 100 as shown in FIG. 1 and the display panel as shown in FIG. 8 is: in the present embodiment, two adjacent data lines 20 have opposite polarities.

Specifically, in the present embodiment, the data lines 20 transmit data signals with a regular sequence of “+, −, +, − . . . ”. When a displayed image of the display panel 100 is switched from a current frame to a next frame, a polarity of each of the data lines 20 is changed. Since four sub-pixel units 30 in each pixel group 3 are connected to four data lines 20 in a one-to-one correspondence, any two adjacent sub-pixel units 30 in a same column have opposite polarities. Therefore, a flicker of an image is reduced.

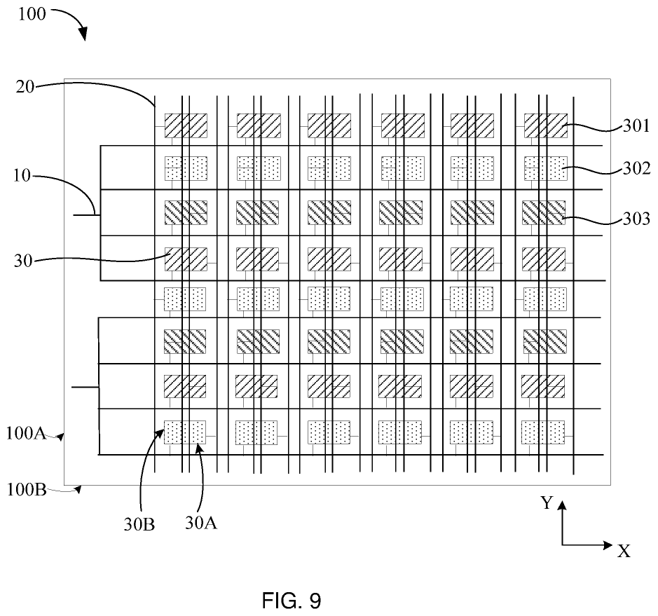

Furthermore, please refer to FIG. 9, an eighth structural schematic view showing a display panel provided by the present disclosure is provided. In the present embodiment, the sub-pixel units 30 may be red sub-pixel units 301, green sub-pixel units 302, or blue sub-pixel units 303. In the sub-pixel units 30 in a same column, the red sub-pixel units 301, the green sub-pixel units 302, and the blue sub-pixel units 303 are repeatedly arranged in any sequence. The sub-pixel units 30 in a same row have a same color.

Specifically, in the sub-pixel units 30 in a same column, the red sub-pixel units 301, the green sub-pixel units 302, and the blue sub-pixel units 303 may be repeatedly arranged in any one sequence of RGB, RBG, BGR, BRG, GRB, or GBR. The present disclosure does not limit the sequence.

It should be understood that the above-mentioned pixel arrangement structure is simple and has mature manufacturing processes. By applying the above-mentioned pixel arrangement structure to the present disclosure, manufacturing processes can be simplified, and production cost can be reduced.

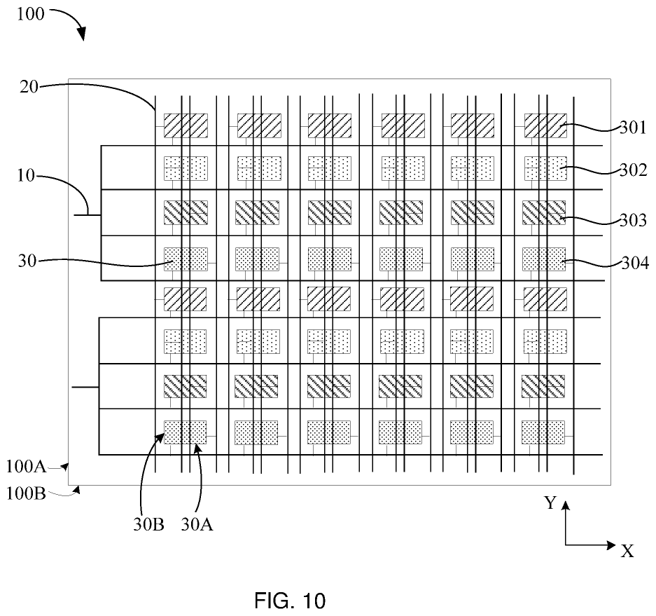

Please refer to FIG. 10, a ninth structural schematic view of a display panel provided by the present disclosure is provided. A difference between the display panel 100 as shown in FIG. 9 and the display panel as shown in FIG. is: in the present embodiment, the sub-pixel units 30 may be red sub-pixel units 301, green sub-pixel units 302, blue sub-pixel units 303, or white sub-pixel units 304. In the sub-pixel units 30 in a same column, the red sub-pixel units 301, the green sub-pixel units 302, the blue sub-pixel units 303, or the white sub-pixel units 304 are repeatedly arranged in any sequence. The sub-pixel units 30 in a same row have a same color.

Specifically, in the sub-pixel units 30, the red sub-pixel units 301, the green sub-pixel units 302, and the blue sub-pixel units 303 may be repeatedly arranged in any one sequence of RGB, RBG, BGR, BRG, GRB, or GBR. The present disclosure does not limit the sequence.

In the present embodiment, the white sub-pixel units 304 are added based on the above RGB pixel arrangement structures to form an RGBW pixel arrangement structure. Adding the white sub-pixel units 304 can significantly increase transmittance of the display panel 100. Also, a brightness of the display panel 100 can be increased based on conventional RGB pixel arrangement structures.

Specifically, in the sub-pixel units 30 in a same column, the red sub-pixel units 301, the green sub-pixel units 302, the blue sub-pixel units 303, and the white sub-pixel units 304 may be repeatedly arranged in any one sequence of RGBW, RBGW, BGRW, BRGW, GRBW, or GBRW. The present disclosure does not limit the sequence.

Of course, the sub-pixel units 30 of the present disclosure may also be arranged in other manners. The above embodiments do not limit the present disclosure.

Correspondingly, the present disclosure further provides an electronic device, including a display panel. The display panel is any one of the display panels mentioned in the above embodiments. Specific description of the display panel can be referred to above contents and is not described again here.

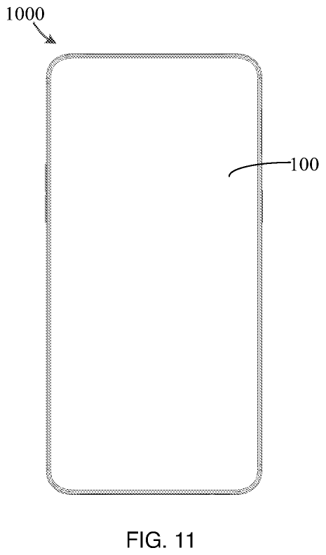

Please refer to FIG. 11, a structural schematic view of an electronic device provided by the present disclosure is provided. An electronic device 1000 includes a display panel 100. The electronic device 1000 may further includes other components such as a housing, a circuit board, etc. which are known by those skilled in the art and are not described here. In addition, the electronic device 1000 may be a smartphone, a tablet, an electronic book reader, a smartwatch, a camera, or a game console. The present disclosure does not limit the electronic device 1000.

The present disclosure provides an electronic device 1000. The electronic device 1000 includes a display panel 100. The display panel 100 includes a plurality of scan lines, a plurality of data lines, and a plurality of sub-pixel units. Wherein, every N adjacent rows of the sub-pixel units share a same scan line. Every N adjacent strips of the data lines correspond to the sub-pixel units in a same row. In the sub-pixel units in a same column, every N adjacent rows of the sub-pixel units form a pixel group, the sub-pixel units of each pixel group are connected to N strips of the data lines in a one-to-one correspondence. N is a positive integer greater than or equal to four. The present disclosure uses one scan line to control N rows of the sub-pixel units. In addition, the sub-pixel units in each column are correspondingly connected to N strips of the data lines. Therefore, when the scan lines output a scan signal, N strips of the data lines can be correspondingly controlled and can be simultaneously charged. As such, a period of each of the pixel units outputting a scan signal can be effectively increased, and a charging time of the display panel 100 can be further increased. As a result, the sub-pixel units can be fully charged, and requirements of a high fresh-rate display can be satisfied.

A display panel and an electronic device provided by the present disclosure have been described in detail by the above embodiments, which illustrates principles and implementations thereof. However, the description of the above embodiments is only for helping to understand the technical solution of the present disclosure and core ideas thereof, and it is understood by those skilled in the art that many changes and modifications to the described embodiment can be carried out without departing from the scope and the spirit of the disclosure that is intended to be limited only by the appended claims.

What is claimed is:

1. A display panel, comprising:
a plurality of scan lines arranged in a column direction;
a plurality of data lines arranged in a row direction; and
a plurality of sub-pixel units arranged in an array manner;
wherein every N adjacent rows of the sub-pixel units are connected to a same scan line, and every N adjacent strips of the data lines correspond to the sub-pixel units in a same column; and
in the sub-pixel units in a same column, every N adjacent rows of the sub-pixel units form a pixel group, the sub-pixel units of each pixel group are connected to N strips of the data lines in a one-to-one correspondence, and N is a positive integer greater than or equal to four.

2. The display panel of claim 1, wherein when N is equal to four, each of the scan lines comprises four sub-scan lines, and one of the sub-scan lines is disposed between two adjacent rows of the sub-pixel units.

3. The display panel of claim 2, wherein four sub-scan lines corresponding to a same scan line are parallelly connected to each other.

4. The display panel of claim 1, wherein when N is equal to four, in every four adjacent rows of the sub-pixel units, the scan lines are disposed between any two adjacent rows of the sub-pixel units.

5. The display panel of claim 1, wherein when N is equal to four, in four adjacent data lines corresponding to the sub-pixel units in a same column, one of the data lines is disposed on a left side of the sub-pixel units in the same column, one of the data lines is disposed on a right side of the sub-pixel units in the same column, and two of the data lines in a middle are disposed in an area corresponding to the sub-pixel units in the same column.

6. The display panel of claim 5, wherein the sub-pixel units comprise a pixel electrode, the pixel electrode comprises a first stem part and a second stem part perpendicular to each other, the first stem part extends along the column direction, and the first stem part overlaps with at least one of the two of the data lines in the middle.

7. The display panel of claim 1, wherein when N is equal to four, in four adjacent data lines corresponding to the sub-pixel units in a same column, two of the data lines are disposed on a left side of the sub-pixel units in the same column, and another two of the data lines are disposed on a right side of the sub-pixel units in the same column; and
one of the two of the data lines disposed on a side of the sub-pixel units in the same column is connected to a corresponding sub-pixel unit by a through hole.

8. The display panel of claim 1, wherein voltage polarities of two adjacent data lines are opposite.

9. The display panel of claim 1, wherein the sub-pixel units comprise a first lateral edge and a second lateral edge adjacent to each other, a length of the first lateral edge is greater than a length of the second lateral edge, and an extending direction of the data lines is parallel to the second lateral edge.

10. The display panel of claim 9, wherein the sub-pixel units comprise a plurality of red sub-pixel units, a plurality of green sub-pixel units, and a plurality of blue sub-pixel units, in the sub-pixel units in a same column, the red sub-pixel units, the green-pixel units, and the blue sub-pixel units are repeatedly arranged in any sequence, and the sub-pixel units in a same row have a same color.

11. The display panel of claim 9, wherein the sub-pixel units comprise a plurality of red sub-pixel units, a plurality of green sub-pixel units, a plurality of blue sub-pixel units, and a plurality of white sub-pixel units, in the sub-pixel units in a same column, the red sub-pixel units, the green-pixel units, the blue sub-pixel units, and the white sub-pixel units are repeatedly arranged in any sequence, and the sub-pixel units in a same row have a same color.

12. An electronic device, comprising a display panel, wherein the display panel comprises:
a plurality of scan lines arranged in a column direction;
a plurality of data lines arranged in a row direction; and
a plurality of sub-pixel units arranged in an array manner;
wherein every N adjacent rows of the sub-pixel units are connected to a same scan line, and every N adjacent strips of the data lines correspond to the sub-pixel units in a same column; and
in the sub-pixel units in a same column, every N adjacent rows of the sub-pixel units form a pixel group, the sub-pixel units of each pixel group are connected to N strips of the data lines in a one-to-one correspondence, and N is a positive integer greater than or equal to four.

13. The electronic device of claim 12, wherein when N is equal to four, each of the scan lines comprises four sub-scan lines, and one of the sub-scan lines is disposed between two adjacent rows of the sub-pixel units.

14. The electronic device of claim 13, wherein four of the sub-scan lines corresponding to a same scan line are parallelly connected to each other.

15. The electronic device of claim 12, wherein when N is equal to four, in every four adjacent rows of the sub-pixel units, the scan lines are disposed between any two adjacent rows of the sub-pixel units.

16. The electronic device of claim 12, wherein when N is equal to four, in four adjacent data lines corresponding to the sub-pixel units in a same column, one of the data lines is disposed on a left side of the sub-pixel units in the same column, one of the data lines is disposed on a right side of the sub-pixel units in the same column, and two of the data lines in a middle are disposed in an area corresponding to the sub-pixel units in the same column.

17. The electronic device of claim 16, wherein the sub-pixel units comprise a pixel electrode, the pixel electrode comprises a first stem part and a second stem part perpendicular to each other, the first stem part extends along the column direction, and the first stem part overlaps with at least one of the two of the data lines in the middle.

18. The electronic device of claim 12, wherein when N is equal to four, in four adjacent data lines corresponding to the sub-pixel units in a same column, two of the data lines are disposed on a left side of the sub-pixel units in the same column, and another two of the data lines are disposed on a right side of the sub-pixel units in the same column; and
one of the two of the data lines disposed on a side of the sub-pixel units in the same column is connected to a corresponding sub-pixel unit by a through hole.

19. The electronic device of claim 12, wherein the sub-pixel units comprise a first lateral edge and a second lateral edge adjacent to each other, a length of the first lateral edge is greater than a length of the second lateral edge, and an extending direction of the data lines is parallel to the second lateral edge.

20. The electronic device of claim 12, wherein the sub-pixel units comprise a plurality of red sub-pixel units, a plurality of green sub-pixel units, a plurality of blue sub-pixel units, and a plurality of white sub-pixel units, in the sub-pixel units in a same column, the red sub-pixel units, the green-pixel units, the blue sub-pixel units, and the white sub-pixel units are repeatedly arranged in any sequence, and the sub-pixel units in a same row have a same color.
